(19) United States
(12) Patent Application Publication
(10) Pub. No.: US 2015/0302316 A1
(43) Pub. Date: Oct. 22, 2015

(54) SYSTEM AND METHOD FOR DETERMINING UNWANTED PHONE MESSAGES

(71) Applicant: Google Inc., Mountain View, CA (US)

(72) Inventors: Kirill Buryak, Sunnyvale, CA (US); Florian David Goerisch, Zurich (CH); Shaopeng Jia, Widen (CH)

(73) Assignee: GOOGLE INC., Mountain View, CA (US)

(21) Appl. No.: 14/258,648

(22) Filed: Apr. 22, 2014

(51) Int. Cl. G06N 99/00; G06N 5/04; H04M 3/22

(52) U.S. Cl. CPC G06N 99/005; H04M 3/2281; G06N 5/04

(57) ABSTRACT

A computer-implemented method for generating a machine-learning model can include receiving, at a computing device having one or more processors, a plurality of reported phone numbers from telephone users, a plurality of posted phone numbers from one or more websites, and transcriptions of messages associated with a plurality of calling phone numbers. The machine-learning model is generated based on these various inputs and stored at the computing device. The model is configured to determine a probability that an unknown phone message is unwanted based on a phone number from which the unknown phone message originated.

### FIELD

The present disclosure relates generally to a method of blocking unwanted phone messages and, more particularly, to a system and method of utilizing a machine learning model to determine whether a phone call, text message, etc. to a user from a particular phone number is likely undesired by the user.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

It is common for individuals that have a computing device (e.g., a mobile phone) at which they can receive phone calls and/or text messages to receive unsolicited and unwanted phone calls and text messages. Such unwanted phone messages are sometimes referred to as “spam” and generally include phone calls, text messages (e.g., SMS messages) and the like. In some instances, a user of such a computing device may be charged a fee for receiving such unwanted phone messages. Even when the user is not charged a fee, however, unwanted phone messages can be viewed as a nuisance by the user.

### SUMMARY

In some embodiments of the present disclosure, a computer-implemented method for generating a machine-learning model is disclosed. The method can include receiving, at a computing device having one or more processors, a plurality of reported phone numbers from telephone users. Each of the plurality of reported phone numbers may have been identified by one of the telephone users as being a source of unwanted phone messages. The method can further include receiving, at the computing device, a plurality of posted phone numbers from one or more websites. Each of the websites may have been identified as a directory of sources of unwanted phone messages. The method can also include receiving, at the computing device, transcriptions of messages associated with a plurality of calling phone numbers. Each transcription including textual data content of a message originating from one of the plurality of calling phone numbers.

The method can additionally include identifying, at the computing device, one or more of the calling phone numbers as potential sources of unwanted phone messages based on the transcriptions. Further, the method can include generating, at the computing device, a machine-learning model based on: (i) the plurality of reported phone numbers, (ii) the plurality of posted phone numbers, and (iii) the one or more calling phone numbers identified as potential sources of unwanted phone messages. The machine-learning model can be configured to determine a probability that an unknown phone message is unwanted based on a phone number from which the unknown phone message originated. The method can also include storing, at the computing device, the machine learning model.

In various embodiments of the present disclosure, a computer system is disclosed. The computer system can include one or more computing devices that each include one or more processors, and a non-transitory, computer readable medium storing instructions that, when executed by the one or more processors, cause the computer system to perform operations.

The operations can include receiving a plurality of reported phone numbers from telephone users. Each of the plurality of reported phone numbers may have been identified by one of the telephone users as being a source of unwanted phone messages. The operations can further include receiving a plurality of posted phone numbers from one or more websites. Each of the websites may have been identified as a directory of sources of unwanted phone messages. The operations can also include receiving transcriptions of messages associated with a plurality of calling phone numbers. Each transcription including textual data content of a message originating from one of the plurality of calling phone numbers.

The operations can additionally include identifying one or more of the calling phone numbers as potential sources of unwanted phone messages based on the transcriptions. Further, the method can include generating a machine-learning model based on: (i) the plurality of reported phone numbers, (ii) the plurality of posted phone numbers, and (iii) the one or more calling phone numbers identified as potential sources of unwanted phone messages. The machine-learning model can be configured to determine a probability that an unknown phone message is unwanted based on a phone number from which the unknown phone message originated. The operations can also include storing, at the computing device, the machine learning model.

In some further embodiments of the present disclosure, a computer-implemented method for generating a machine-learning model is disclosed. The method can include receiving, at a computing device having one or more processors, a plurality of reported phone numbers from telephone users. Each of the plurality of reported phone numbers may have been identified by one of the telephone users as being a source of unwanted phone messages. The method can further include receiving, at the computing device, a plurality of posted phone numbers from one or more websites. Each of the websites may have been identified as a directory of sources of unwanted phone messages. The method can also include receiving, at the computing device, transcriptions of messages associated with a plurality of calling phone numbers. Each transcription including textual data content of a message originating from one of the plurality of calling phone numbers.

The method can additionally include identifying, at the computing device, one or more of the calling phone numbers as potential sources of unwanted phone messages based on the transcriptions. Further, the method can include generating, at the computing device, a machine-learning model based on: (i) the plurality of reported phone numbers, (ii) the plurality of posted phone numbers, and (iii) the one or more calling phone numbers identified as potential sources of unwanted phone messages. The machine-learning model can be configured to determine a probability that an unknown phone message is unwanted based on a phone number from which the unknown phone message originated.

The method can also include generating, at the computing device, a database of phone numbers based on the model. The database can include a plurality of phone numbers associated with a plurality of probabilities, where each of the plurality of phone numbers is associated with one of the plurality of probabilities. Each of the plurality of probabilities can represent a likelihood that a phone message originating from its associated phone number is unwanted. The method can further include receiving, at the computing device, an indication of an unknown phone message to a user, where the indication includes an originating telephone number. Additionally, the method can include determining, at the computing device, a classification of the originating telephone number based on the database of phone numbers. The classification can be one of a probable source of unwanted phone messages and an improbable source of unwanted phone messages. Further, the method can include routing, from the computing device, the unknown phone message to the user based on the classification of the originating telephone number and a message routing policy of the user.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example computing system according to some implementations of the present disclosure;

FIG. 2 is another functional block diagram of the example computing system of FIG. 1 according to some implementations of the present disclosure;

FIG. 3 is a flow diagram of an example method for generating a machine-learning model configured to determine probability that an unknown phone message is unwanted according to some implementations of the present disclosure; and

FIG. 4 is a flow diagram of an example method for utilizing a machine-learning model that is configured to determine probability that an unknown phone message is unwanted according to some implementations of the present disclosure.

### DETAILED DESCRIPTION

As mentioned above, a user of a computing device (e.g., a mobile phone) at which he or she can receive unwanted phone messages may find such messages a nuisance, even if the user is not charged a fee for receiving them. In some cases, telephony or other service providers may provide the user with the ability to block certain unwanted phone messages. For example, a user can utilize a “black list” of phone numbers from which the user does not want to receive phone messages. Such black lists can, e.g., be created by the user, by a group of users, and/or by the service provider, which in some cases can be adapted or tailored by the user. The user can also create or adopt a message routing policy that specifies how a phone message from a phone number on the black list is to be routed. When such a phone message is received, the phone message can be handled in accordance with the user's message routing policy.

While useful, black lists can have disadvantages. For example only, typical black lists are reactionary in that they only include phone numbers that are known or reported to be sources of unwanted phone messages. Therefore, there may be a delay between when a phone number becomes associated with unwanted phone messages and when it is identified (e.g., reported and confirmed) as a source of unwanted phone messages. During this delay period, many unwanted phone messages can be delivered to users utilizing the black list. Accordingly, it would be desirable to provide an improved method and system of determining unwanted phone messages that eliminates or reduces such delay periods and/or is configured to predict likely sources of unwanted phone messages.

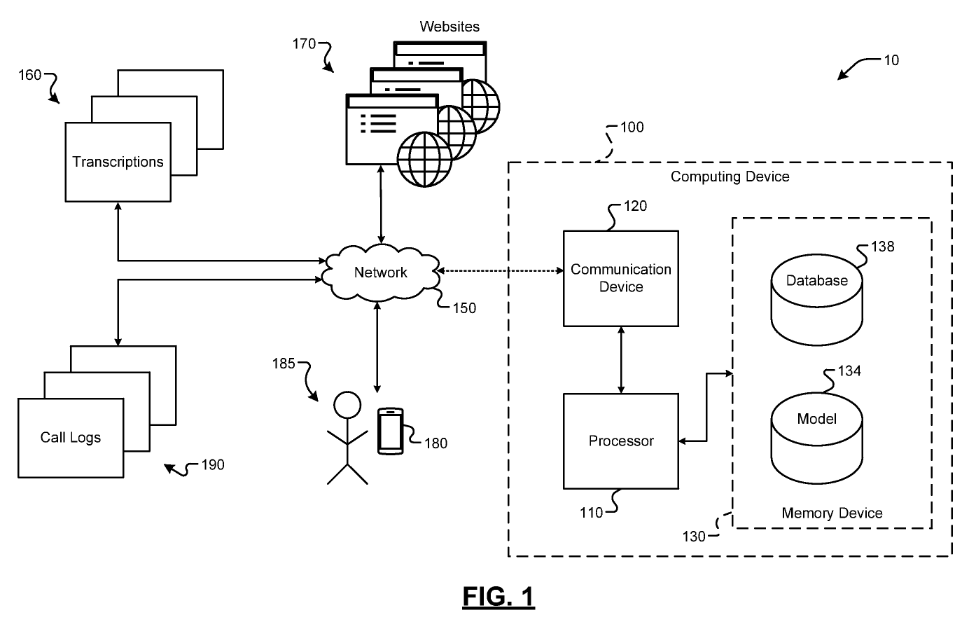

With initial reference to FIG. 1, an example computing system 10 for performing the techniques of generating and utilizing a machine-learning model for determining unwanted phone messages as described herein is illustrated. The computing system 10 can include one or more computing devices 100. For simplicity of description, the term “computing device” as used herein refers to both a single computing device, as well as two or more computing devices operating together, e.g., in a parallel or distributed architecture, to perform operations.

The computing device 100 can include a processor 110, a communication device 120 and a memory device 130. It should be appreciated that the computing device 100 can include additional computing components that are not illustrated in FIG. 1, such as input and/or output devices (a microphone, a speaker, a keyboard, one or more buttons, etc.). In some embodiments, the example computing device 100 can be a server computing device, although other types of computing devices are specifically included within the scope of this disclosure.

The term “processor” as used herein refers to both a single processor, as well as two or more processors operating together, e.g., in a parallel or distributed architecture, to perform operations of the computing device 100. The processor 110 controls most operations of the computing device 100. For example, the processor 110 may perform tasks such as, but not limited to, loading/controlling the operating system of the computing device 100, loading/configuring communication parameters for the communication device 120, and controlling storage/retrieval operations from the memory device 130 (and the associated model 134 and database 138 described below).

The communication device 120 controls communication between the computing device 100 and other devices/networks. For example only, the communication device 120 may provide for communication between the computing device 100 and other computing devices via a network 150. The network 150 includes any type of communication medium, for example, the Internet, a local area or wide area computer network (LAN, WAN), a mobile telephone network, and a satellite network. The memory device 130 can comprise any suitable storage medium (flash, hard disk, distributed storage, etc.) configured to store information at the computing device 100.

The computing device 100 can be in communication with various other computing devices/systems via the network 150. As more fully described below, the computing device 100 can receive a plurality of transcriptions 160 via the network 150. Additionally, the computing device 100 can be in communication with one or more websites 170, as well as one or more telephone users 185 and their associated computing devices 180. While the computing device 180 is illustrated as a smart phone, it should be appreciated that the computing device 180 could be any computer or computer system that is capable of receiving phone messages. Furthermore, the term “phone message” as used herein includes telephonic calls, voicemails, short messaging service (SMS) and other text messages, and all other forms of communications that utilize a phone number as the originating address of the communication.

The computing device 100 can generate and implement a machine-learning model 134. The model 134 can be configured to determine a probability that an unknown phone message is unwanted based on the phone number from which the unknown phone message originated. Additionally, the computing device 100 can generate and implement a database 138 of phone numbers based on the model 134. While the model 134 and database 138 are illustrated in FIG. 1 as being a component of the memory device 130, it should be appreciated that one or both of these components can be partially or wholly implemented by the processor 110.

The computing device 100 can receive a plurality of reported phone numbers from telephone users, such as telephone user 185 via computing device 180. In some embodiments, the computing device 180 can present the user 185 with the option of reporting a particular phone message, e.g., via a user interface of the computing device 180, as unwanted when the computing device 180 receives the phone message. The computing device 100 will receive an indication that the reported phone number is unwanted, and may include additional information regarding the phone message (e.g., textual data content of the phone message). In this manner, which is sometimes referred to as crowdsourcing, the computing device 100 can receive a potentially large number of reported phone numbers.

In addition to the reported phone numbers, the computing device 100 can receive a plurality of posted phone numbers from one or more websites 170 that are identified as a directory of sources of unwanted phone messages. For example, some websites allow users 185 to post phone numbers as being sources of unwanted phone messages. These websites 170 will publish these phone numbers as posted phone numbers. The computing device 100 can utilize an automatic indexer (Web spider, Web crawler, etc.) to retrieve the posted phone numbers from the websites 170. In some embodiments, the computing device 100 will be manually directed to websites 170 that are known to be directories of sources of unwanted phone messages. Additionally or alternatively, the computing device 100 can be tasked to identify particular websites 170 as possibly being directories of sources of unwanted phone messages, as further described below.

The computing device 100 can index a large collection of websites, and utilize various features of the websites to identify which of the collection, if any, are directories of sources of unwanted phone messages. For example only, if a website does not contain a large number of phone numbers, it is unlikely to be such a directory. The presence of a large number of phone numbers by itself, however, may not be a very reliable feature of identifying such directories as there may be many websites that are phone directories that do not purport to identify sources of unwanted phone messages. Therefore, the computing device 100 may utilize the feature of containing a large number of phone numbers with the additional feature of containing one or more of the words “telemarketer,” “spam,” “annoying,” “nuisance,” etc. to assist in the identification. It should be appreciated that this is not an exhaustive list of features that may be useful to identify such directories.

Based on the features, the computing device 100 can use a statistical model to identify a probability that a particular website is such a directory. Based on the probability, the computing device 100 can identify or classify websites as directories of sources of unwanted phone messages. In some embodiments, the computing device 100 can also receive a reliability metric for each of the one or more websites 170 identified as a probable directory of sources of unwanted phone messages. The reliability metric is a measure or estimate of the likelihood that a website is trustworthy or otherwise an acceptable source of information. Features upon which the reliability metric for a website can be based include, but are not limited to, age of website, history of the website, location where the website is hosted, and the company or entity with which the website is associated.

The reliability metric can be utilized by the computing device 100 in conjunction with the posted phone numbers to generate the machine-learning model 134. In some embodiments, if the reliability metric is below a threshold, the posted phone numbers from the website will not be utilized by the computing device 100. In other embodiments, the reliability metric can be used to generate a weight for each of the plurality of posted phone numbers. These weights can be utilized by the computing device 100 to generate the machine-learning model 134, as further described below.

Additionally or alternatively, the computing device 100 can receive transcriptions 160 of messages associated with a plurality of calling phone numbers. The transcriptions 160 can include textual data content of a phone message originating from a calling phone number. Examples of the transcriptions 160 include the text from a text message and a transcription generated from a voicemail message using speech-to-text functionality. A telephone user (such as user 185) will consent to provide access to such transcriptions.

The computing device 100 can identify one or more of the calling phone numbers as potential sources of unwanted phone messages based on the transcriptions 160. The transcriptions can be analyzed by the computing device 100 to identify unwanted phone messages, e.g., using a statistical model. For example only, transcriptions 160 that include text describing penny stocks, interest rates, credit scores or other typical topics of unwanted phone messages may be identified as being associated with a source of unwanted phone messages. Additionally, if there are many identical or nearly identical transcriptions 160 originating from the same phone number delivered to different users 185, this may be a feature associated with typical sources of unwanted phone messages. Further, if a large number of transcriptions 160 originate from the same phone number in a short period of time, this also may be indicative of typical sources of unwanted phone messages. It should be appreciated that this is not an exhaustive list of features that may be useful to identify such sources from transcriptions 160.

In some embodiments, the computing device 100 can additionally or alternatively receive one or more call logs 190 that include indications of phone messages associated with one or more logged phone numbers. In contrast to the transcriptions 160 described above, the call logs 190 do not include any textual data content of associated phone messages. Instead, the call logs 190 merely include one or more logged phone numbers and an indication that the logged phone numbers have generated a phone message. In some embodiments, the call logs 190 include logged phone numbers and an indication of the times associated with each of the phone messages generated by the logged phone numbers. Alternatively, the call logs 190 can include the logged phone numbers and a count associated with the number of phone messages originating from the logged phone numbers over a specific period of time. It should be appreciated that the computing device 100 can receive the call logs 190 by receiving indication(s) of phone messages from the logged phone numbers and generating the call logs 190 from these indication(s).

The computing device 100 can identify one or more of the logged phone numbers as potential sources of unwanted phone messages based on the call logs 190. The call logs 190 can be analyzed by the computing device 100 to identify unwanted phone messages, e.g., using a statistical model. For example only, if a call log 190 indicates that a large number of phone messages originated from the same logged phone number in a short period of time, this may be indicative of a typical source of unwanted phone messages. The thresholds associated with the number of phone messages and/or the period of time can be determined, e.g., by utilizing a machine learning model on known sources of unwanted phone messages.

Based on the above, the computing device 100 can generate a machine-learning model 134 that is configured to determine a probability that an unknown phone message is unwanted based on the phone number from which the unknown phone message originated. To generate the model 134, the computing device 100 can utilize one or more of: (i) the plurality of reported phone numbers, (ii) the plurality of posted phone numbers, (iii) the one or more calling phone numbers identified as potential sources of unwanted phone messages, and (iv) the one or more logged phone numbers identified as potential sources of unwanted phone messages. In some embodiments, the model 134 can be further based on the weights for the posted phone numbers described above. The model 134 can be stored by the computing device 100, e.g., in the memory device 130 or elsewhere.

As mentioned above, the model 134 is configured to determine a probability of an unknown phone message being an unwanted phone message. The model 134 can utilize one or more of the reported phone numbers, the posted phone numbers, and the one or more calling phone numbers identified as potential sources of unwanted phone messages as training data from which the model 134 is trained. In some embodiments, the reported phone numbers, the posted phone numbers, and the one or more calling phone numbers are classified as sources of unwanted phone messages.

In various embodiments, each number of the reported phone numbers, the posted phone numbers, and the one or more calling phone numbers can be assigned a probability or weight. The probability or weight can be representative of the likelihood that the phone number is a source of unwanted phone messages. For the reported phone numbers, it may be assumed that the reporting users are relatively accurate in their classifications. Thus, it may be reasonable to set the probability of reported phone numbers to a relatively high number. For the posted phone numbers, the reliability metric can be used to generate the probability or weight.

With respect to the calling numbers, the transcriptions 160 can be analyzed by the computing device 100. The textual data content of each transcription 160 can be analyzed by a model (not shown) that has been trained to identify unwanted phone messages based on textual data content. In some embodiments, the model will classify each transcription 160 in a binary fashion, that is, it is an unwanted phone message or it is not. In other embodiments, the model will determine a probability that each transcription 160 represents an unwanted phone messages. In these embodiments, the probabilities can be used directly or indirectly to generate the appropriate weight for the one or more calling numbers.

The computing device 100 can also generate a database 138 of phone numbers based on the model 134. The database 138 can include a plurality of phone numbers associated with a plurality of probabilities. Each of the plurality of phone numbers is associated with one of the probabilities that represents the likelihood that a phone message originating from its associated phone number is unwanted. The probabilities can be generated from the model 134 based on the weights/probabilities described above. The computing device 100 can utilize the database 138 and/or provide the database 138 to a plurality of computing devices (e.g., 180) for use.

The model 134 and database 138 generated therefrom have the advantage of being configured to determine a likelihood of a phone message being unwanted even if the phone number from which it originated is absent from (i) the plurality of reported phone numbers, (ii) the plurality of posted phone numbers, (iii) the one or more calling phone numbers identified as potential sources of unwanted phone messages, and (iv) the one or more logged phone numbers identified as potential sources of unwanted phone messages. In some embodiments, the model 134 may determine with a high likelihood that phone numbers within a range are sources of unwanted phone messages. For example only, if the model 134 determines that (650) XXX-XX30 to -XX32, and -XX34 to -XX39 are sources of unwanted messages, the model 134 may determine that all numbers with the prefix (650) XXX-XX3* represent sources of unwanted messages. This predictive ability of the model 134 (and database 138) can reduce or eliminate the delay periods described above.

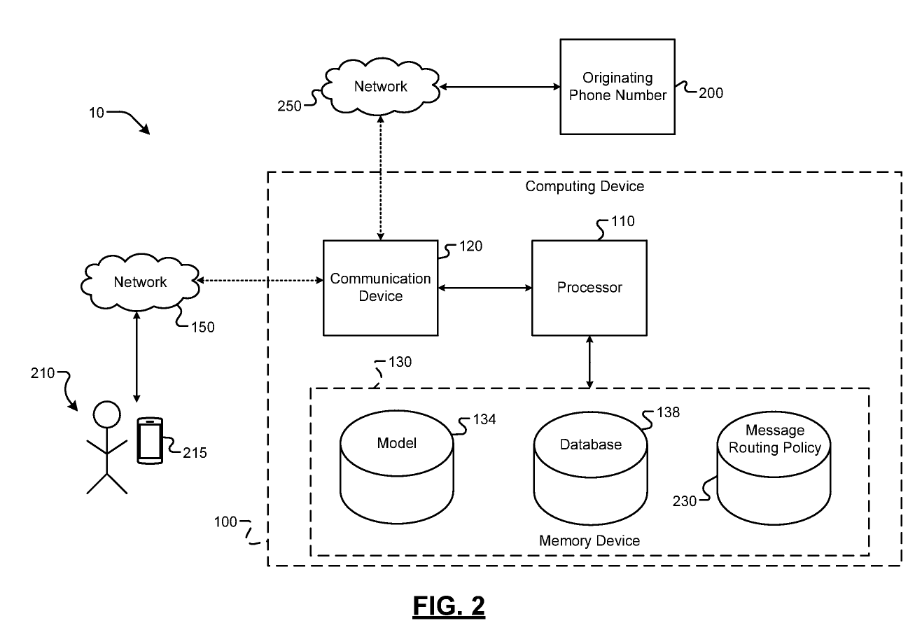

Operation of the example computing system 10 of FIG. 1 when receiving an unknown phone message from an originating phone number 200 will be described with reference to FIG. 2. In FIG. 2, the computing device 100 is illustrated as an intermediary between the originating phone number 200 and a user 210 and associated computing device 215 that is the intended recipient of the unknown phone message. The unknown phone message originates at the originating phone number 200 and is transmitted via a network 250 to the computing device 100. The computing device 100 then routes, according to a message routing policy 230 associated with the user 210, the unknown phone message to the user 210 via the network 150, as described more fully below.

The computing device 100 receives an indication of an unknown phone message to the user 210, where the indication includes the origination phone number 200. The computing device 100 can determine a classification of the originating phone number based on the model 134 and/or database 138. The classification can be, e.g., (i) a probable source of unwanted phone messages, or (ii) an improbable source of unwanted phone messages. The computing device 100 can then route the unknown phone message to the user 210 based on the classification and of the originating telephone number 200 and a message routing policy 230 of the user 210.

The message routing policy 230 of the user 210 can provide instructions to the computing device 100 regarding preferences of the user 210 on how to route unknown phone messages. In some cases, a user (such as user 210) may desire all phone messages, regardless of the source, to be transmitted to the user 210. In other cases, a user may prefer to block any unknown phone message that originates from a probable source of unwanted phone messages. In further cases, a user may wish to block only those unwanted phone messages that originate at an originating phone number that has a very high likelihood of being a source of unwanted phone messages. In even further cases, a user may desire that different types of unknown phone messages be handled differently. For example only, a user can specify that a phone call from an originating phone number that is classified as a probable source of unwanted phone messages is blocked, while permitting voicemails and/or text messages from the same source to be transmitted.

It is contemplated that the user 210 will configure his/her message routing policy 230 in advance of the processing of unknown phone messages, although a default message routing policy 230 can be utilized for those users that have not specified a custom policy. The computing device 100 can store the message routing policy 230 of the user 210, e.g., at the memory device 130, for later use.

It should be appreciated, however, that the computing device 100 can alternatively be separate from the computing device(s) associated with the routing of phone messages to the user 210. For example only, the computing device 100 can instead be a recipient of an application programming interface (API) call from the computing device(s) associated with the routing of phone messages. In this example, the routing computing device(s) can provide the computing device 100 with an indication of an unknown phone message to the user 210, where the indication includes the origination phone number 200. The computing device 100 can determine a classification of the originating phone number based on the model 134 and/or database 138. The classification can be, e.g., (i) a probable source of unwanted phone messages, or (ii) an improbable source of unwanted phone messages.

In some embodiments, the classification is sent back to the computing device(s) associated with the routing of phone messages to the user 210 for use. Alternatively, the computing device 100 can instead provide an instruction regarding the routing of the unknown phone message, e.g., based on the classification and the message routing policy 230, to the computing device(s) associated with the routing of phone messages to the user 210. In either case, the computing device(s) associated with the routing of phone messages to the user 210 will utilize the classification or instruction to route the unknown phone message to the user.

In order to further improve the generated machine-learning model 134, the computing device 100 can also provide an option to receive feedback from users (such as the user 210) regarding the accuracy of the classification of a routed unknown phone message. In conjunction with the computing device 100 routing the unknown phone message to the user 210 based on his/her message routing policy 230, the computing device 100 can provide a message to the user 210 and his/her associated computing device 215. The user 210 can respond to the message and identify the unknown phone message as either: (i) an unwanted phone message, or (ii) not an unwanted phone message.

This feedback can be utilized to further adapt the machine-learning model 134 to assist in classifying the phone number from which the unknown phone message originated as: (i) a probable source of unwanted phone messages, or (ii) an improbable source of unwanted phone messages identifying. For example only, if the user 210 provides feedback identifying the unknown phone message as being an unwanted phone message, the phone number from which the unknown phone message originated can be converted into a reported phone number.

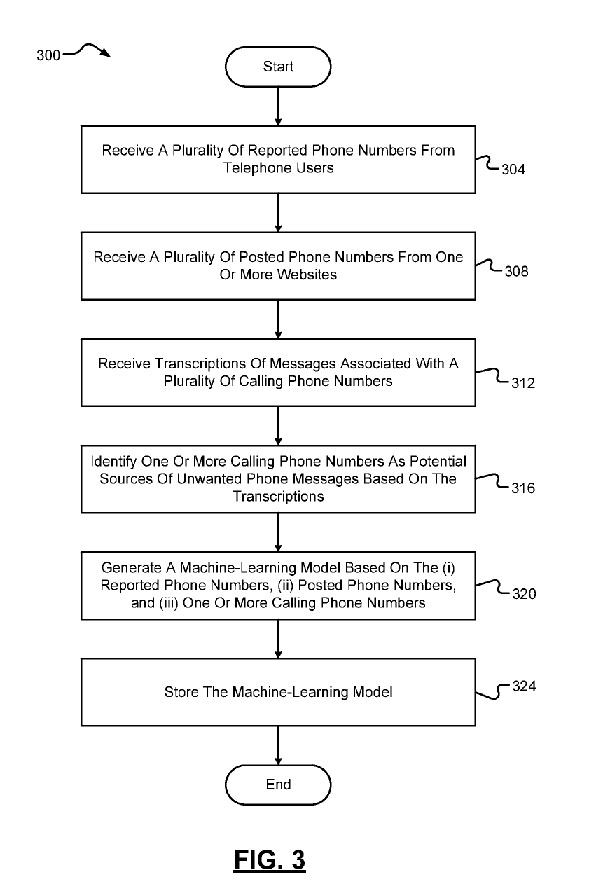

Referring now to FIG. 3, an example method 300 for generating a machine-learning model according to some embodiments of the present disclosure is illustrated. While described as being performed by the computing device 100, it should be appreciated that the operations can be performed by one or more specific components of the computing device 100 (such as the processor 110 or the communication device 120), one or more additional computing devices, or a combination of these elements. Further, the method 300 can be implemented by a computer system 10 that includes: (i) one or more computing devices, each computing device including one or more processors, and (ii) a non-transitory, computer readable medium storing instructions that, when executed by the one or more processors, cause the computer system to perform the operations of the method 300.

At 304, the computing device 100 can receive a plurality of reported phone numbers from telephone users, such as telephone user 185 via computing device 180. As described above, each of the plurality of reported phone numbers may have been identified by one of the telephone users as being a source of unwanted phone messages. At 308, the computing device 100 can receive a plurality of posted phone numbers from one or more websites 170. Each of the websites 170 is identified as a directory of sources of unwanted phone messages. As described above, in some embodiments the computing device 100 identifies the websites 170 as directories of sources of unwanted phone messages, e.g., from a plurality of indexed websites.

The computing device 100 can receive transcriptions 160 of messages associated with a plurality of calling phone numbers at 312. The transcriptions 160 can include textual data content of a phone message originating from a calling phone number. Examples of the transcriptions 160 include the text from a text message and a transcription generated from a voicemail message using speech-to-text functionality. At 316, the computing device 100 can identify one or more of the calling numbers as potential sources of unwanted phone messages based on the transcriptions 160.

At 324, the computing device 100 can generate a machine-learning model 134 based on (i) the plurality of reported phone numbers, (ii) the plurality of posted phone numbers, and (iii) the one or more calling phone numbers identified as potential sources of unwanted phone messages. The model 134 can be configured to determine a probability that an unknown phone message is unwanted based on the phone number from which the unknown phone message originated.

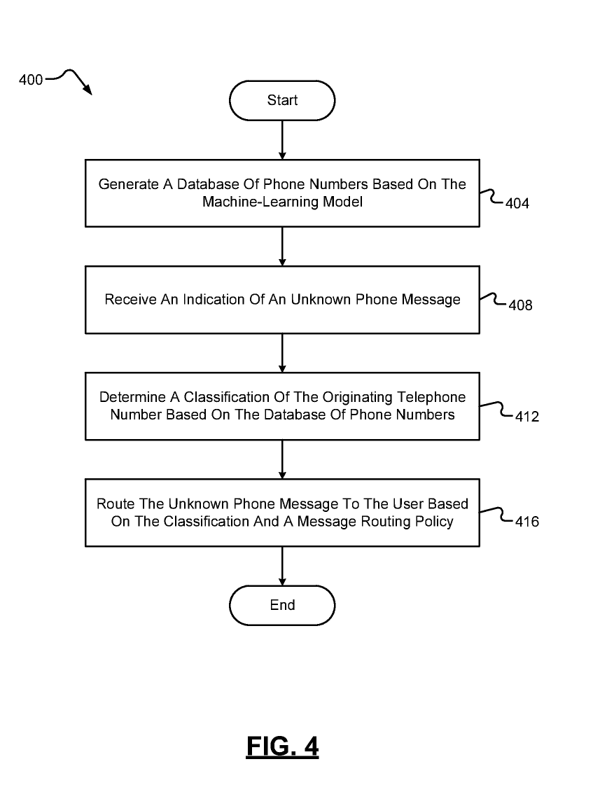

Referring now to FIG. 4, an example method 400 for utilizing the machine-learning model 134 according to some embodiments of the present disclosure is illustrated. While described as being performed by the computing device 100, it should be appreciated that the operations can be performed by one or more specific components of the computing device 100 (such as the processor 110 or the communication device 120), one or more additional computing devices, or a combination of these elements. Further, the method 400 can be implemented by a computer system 10 that includes: (i) one or more computing devices, each computing device including one or more processors, and (ii) a non-transitory, computer readable medium storing instructions that, when executed by the one or more processors, cause the computer system to perform the operations of the method 400.

At 404, the computing device 100 can generate a database 138 of phone numbers based on the machine-learning model 134. The database 138 can include a plurality of phone numbers associated with a plurality of probabilities. Each of the plurality of phone numbers is associated with one of the probabilities that represents the likelihood that a phone message originating from its associated phone number is unwanted. The probabilities can be generated from the model 134 based on the weights/probabilities described above.

At 408, the computing device 100 can receive an indication of an unknown phone message to a user (such as the user 210). The indication can include an originating telephone number of the unknown phone message. The computing device 100 can determine a classification of the originating phone number based on the model 134 and/or database 138 at 412. The classification can be, e.g., (i) a probable source of unwanted phone messages, or (ii) an improbable source of unwanted phone messages. The computing device 100 can then route (at 416) the unknown phone message to the user 210 based on the classification and of the originating telephone number 200 and a message routing policy 230 of the user 210.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a computing device having one or more processors, a plurality of reported phone numbers from telephone users, each of the plurality of reported phone numbers being identified by one of the telephone users as being a source of unwanted phone messages;
receiving, at the computing device, a plurality of posted phone numbers from one or more websites, each of the websites being identified as a directory of sources of unwanted phone messages;
receiving, at the computing device, transcriptions of messages associated with a plurality of calling phone numbers, each transcription including textual data content of a message originating from one of the plurality of calling phone numbers;
identifying, at the computing device, one or more of the calling phone numbers as potential sources of unwanted phone messages based on the transcriptions;
generating, at the computing device, a machine-learning model based on: (i) the plurality of reported phone numbers, (ii) the plurality of posted phone numbers, and (iii) the one or more calling phone numbers identified as potential sources of unwanted phone messages, the machine-learning model being configured to determine a probability that an unknown phone message is unwanted based on a phone number from which the unknown phone message originated; and
storing, at the computing device, the machine learning model.

2. The computer-implemented method of claim 1, wherein at least one of the transcriptions is generated from a voicemail message via speech-to-text.

3. The computer-implemented method of claim 1, further comprising:
receiving, at the computing device, one or more call logs associated with a plurality of logged phone numbers, each call log including an indication that the logged phone numbers generated a phone message during a period of time; and
identifying, at the computing device, one or more of the logged phone numbers as potential sources of unwanted phone messages based on the call logs,
wherein the machine-learning model is generated based on the one or more logged phone numbers identified as potential sources of unwanted phone messages.

4. The computer-implemented method of claim 1, further comprising identifying, at the computing device, the one or more websites as a directory of sources of unwanted phone messages.

5. The computer-implemented method of claim 1, further comprising
receiving, at the computing device, a reliability metric for each of the one or more websites; and
generating, at the computing device, a weight for each of the plurality of posted phone numbers based on the reliability metrics,
wherein the machine-learning model is further based on the weight for each of the plurality of posted phone numbers.

6. The computer-implemented method of claim 1, wherein the model is configured to determine the probability that the unknown phone message is unwanted based on the phone number from which the unknown phone message originated for phone numbers that are absent from (i) the plurality of reported phone numbers, (ii) the plurality of posted phone numbers, and (iii) the one or more calling phone numbers.

7. The computer-implemented method of claim 1, further comprising:
generating, at the computing device, a database of phone numbers based on the model, the database including a plurality of phone numbers associated with a plurality of probabilities, each of the plurality of phone numbers being associated with one of the plurality of probabilities, each of the plurality of probabilities representing a likelihood that a phone message originating from its associated phone number is unwanted; and
providing, from the computing device, the database of phone numbers to a plurality of computing devices for use.

8. The computer-implemented method of claim 1, further comprising:
receiving, at the computing device, an indication of an unknown phone message to a user, the indication including an originating telephone number;
determining, at the computing device, a classification of the originating telephone number based on the model, the classification being one of a probable source of unwanted phone messages and an improbable source of unwanted phone messages; and
routing, from the computing device, the unknown phone message to the user based on the classification of the originating telephone number and a message routing policy of the user.

9. A computer system, comprising:
one or more computing devices, each of the computing devices including one or more processors; and
a non-transitory, computer readable medium storing instructions that, when executed by the one or more processors, cause the computer system to perform operations comprising:
receiving a plurality of reported phone numbers from telephone users, each of the plurality of reported phone numbers being identified by one of the telephone users as being a source of unwanted phone messages;
receiving a plurality of posted phone numbers from one or more websites, each of the websites being identified as a directory of sources of unwanted phone messages;
receiving transcriptions of messages associated with a plurality of calling phone numbers, each transcription including textual data content of a message originating from one of the plurality of calling phone numbers;
identifying one or more of the calling phone numbers as potential sources of unwanted phone messages based on the transcriptions;
generating a machine-learning model based on: (i) the plurality of reported phone numbers, (ii) the plurality of posted phone numbers, and (iii) the one or more calling phone numbers identified as potential sources of unwanted phone messages, the machine-learning model being configured to determine a probability that an unknown phone message is unwanted based on a phone number from which the unknown phone message originated; and
storing the machine learning model.

10. The computer system of claim 9, wherein at least one of the transcriptions is generated from a voicemail message via speech-to-text.

11. The computer system of claim 9, wherein the operations further comprise:
receiving one or more call logs associated with a plurality of logged phone numbers, each call log including an indication that the logged phone numbers generated a phone message during a period of time; and
identifying one or more of the logged phone numbers as potential sources of unwanted phone messages based on the call logs,
wherein the machine-learning model is generated based on the one or more logged phone numbers identified as potential sources of unwanted phone messages.

12. The computer system of claim 9, wherein the operations further comprise identifying the one or more websites as a directory of sources of unwanted phone messages:

13. The computer system of claim 9, wherein the operations further comprise:
receiving a reliability metric for each of the one or more websites; and
generating a weight for each of the plurality of posted phone numbers based on the reliability metrics,
wherein the machine-learning model is further based on the weight for each of the plurality of posted phone numbers.

14. The computer system of claim 9, wherein the model is configured to determine the probability that the unknown phone message is unwanted based on the phone number from which the unknown phone message originated for phone numbers that are absent from (i) the plurality of reported phone numbers, (ii) the plurality of posted phone numbers, and (iii) the one or more calling phone numbers.

15. The computer system of claim 9, wherein the operations further comprise:
generating a database of phone numbers based on the model, the database including a plurality of phone numbers associated with a plurality of probabilities, each of the plurality of phone numbers being associated with one of the plurality of probabilities, each of the plurality of probabilities representing a likelihood that a phone message originating from its associated phone number is unwanted; and
providing the database of phone numbers to a plurality of computing devices for use.

16. The computer system of claim 8, wherein the operations further comprise:
receiving an indication of an unknown phone message to a user, the indication including an originating telephone number;
determining a classification of the originating telephone number based on the model, the classification being one of a probable source of unwanted phone messages and an improbable source of unwanted phone messages; and
routing the unknown phone message to the user based on the classification of the originating telephone number and a message routing policy of the user.

17. A computer-implemented method, comprising:
receiving, at a computing device having one or more processors, a plurality of reported phone numbers from telephone users, each of the plurality of reported phone numbers being identified by one of the telephone users as being a source of unwanted phone messages;
receiving, at the computing device, a plurality of posted phone numbers from one or more websites, each of the websites being identified as a directory of sources of unwanted phone messages;
receiving, at the computing device, transcriptions of messages associated with a plurality of calling phone numbers, each transcription including textual data content of a message originating from one of the plurality of calling phone numbers;
identifying, at the computing device, one or more of the calling phone numbers as potential sources of unwanted phone messages based on the transcriptions;
generating, at the computing device, a machine-learning model based on: (i) the plurality of reported phone numbers, (ii) the plurality of posted phone numbers, and (iii) the one or more calling phone numbers identified as potential sources of unwanted phone messages, the machine-learning model being configured to determine a probability that an unknown phone message is unwanted based on a phone number from which the unknown phone message originated;
generating, at the computing device, a database of phone numbers based on the model, the database including a plurality of phone numbers associated with a plurality of probabilities, each of the plurality of phone numbers being associated with one of the plurality of probabilities, each of the plurality of probabilities representing a likelihood that a phone message originating from its associated phone number is unwanted;
receiving, at the computing device, an indication of an unknown phone message to a user, the indication including an originating telephone number;
determining, at the computing device, a classification of the originating telephone number based on the database of phone numbers, the classification being one of a probable source of unwanted phone messages and an improbable source of unwanted phone messages; and
routing, from the computing device, the unknown phone message to the user based on the classification of the originating telephone number and a message routing policy of the user.

18. The computer-implemented method of claim 17, wherein the database of phone numbers includes phone numbers that are absent from (i) the plurality of reported phone numbers, (ii) the plurality of posted phone numbers, and (iii) the one or more calling phone numbers.

19. The computer-implemented method of claim 18, further comprising:
determining, at the computing device, a classification of each phone number in the database of phone numbers based on the model, the classification being one of a probable source of unwanted phone messages and an improbable source of unwanted phone messages,
wherein at least one of the phone numbers that are absent from (i) the plurality of reported phone numbers, (ii) the plurality of posted phone numbers, and (iii) the one or more calling phone numbers is classified as a probable source of unwanted phone messages.

20. The computer-implemented method of claim 17, further comprising:
receiving, at the computing device, a reliability metric for each of the one or more websites; and
generating, at the computing device, a weight for each of the plurality of posted phone numbers based on the reliability metric,
wherein the machine-learning model is further based on the weight for each of the plurality of posted phone numbers.
